(19) United States
(12) Patent Application Publication
(10) Pub. No.: US 2015/0322335 A1
(43) Pub. Date: Nov. 12, 2015

(54) SILICONE-PHENOLIC COMPOSITIONS, COATINGS AND PROPPANTS MADE THEREOF, METHODS OF MAKING AND USING SAID COMPOSITIONS, COATINGS AND PROPPANTS, METHODS OF FRACTURING

(71) Applicant: CLARENCE RESINS & CHEMICALS, INC., CLARENCE CENTER, NY (US)

(72) Inventor: JAMES GREGORY LAWRENCE, CLARENCE CENTER, NY (US)

(73) Assignee: CLARENCE RESINS & CHEMICALS, INC., CLARENCE CENTER, NY (US)

(21) Appl. No.: 14/274,760

(22) Filed: May 11, 2014

(51) Int. Cl. C09K 8/80; E21B 43/267

(52) U.S. Cl. CPC C09K 8/805; E21B 43/267

(57) ABSTRACT

A silicone phenolic coating composition is useful for coating silica containing substrates to form products useful in hydraulic fracturing. The coating composition comprises self crosslinking phenolic prepolymers, with the silica in the sand being bridged to the silica in the coating composition by oxygen.

### RELATED APPLICATION DATA

Not applicable.

### 1. FIELD OF THE INVENTION

The present invention relates to compositions, products made thereof, and methods of making and using said compositions and products. In another aspect, the present invention relates to coating compositions, coatings and coated products made thereof, and methods of making and using said coating compositions, coatings and coated products. In even another aspect, the present invention relates to proppant coatings, to coated proppants, to well fluids comprising such coated proppants, to methods of making and using said coatings, proppants and well fluids, to methods of fracturing a well with said proppants and well fluids, and to a well comprising such proppants and well fluids. In yet another aspect, the present invention relates to silane-phenolic coatings, proppants coated therewith, well fluids comprising such proppants, to methods of making and using said coatings, proppants and well fluids, to methods of fracturing a well with said proppants and well fluids, and to a well comprising such proppants and well fluids.

### 2. DESCRIPTION OF THE RELATED ART

Oil and natural gas are produced from wells having porous and permeable subterranean formations. The porosity of the formation permits the formation to store oil and gas, and the permeability of the formation permits the oil or gas fluid to move through the formation. Permeability of the formation is essential to permit oil and gas to flow to a location where it can be pumped from the well. Sometimes the permeability of the formation holding the gas or oil is insufficient for economic recovery of oil and gas. In other cases, during operation of the well, the permeability of the formation drops to the extent that further recovery becomes uneconomical.

In such an instance, well fracturing is an often used technique to increase the efficiency and productivity of oil and gas wells. Overly simplified, the process involves the introduction of a fracturing fluid into the well and the use of fluid pressure to fracture and crack the well strata. The cracks allow the oil and gas to flow more freely from the strata and thereby increase production rates in an efficient manner.

There are many detailed techniques involved in well fracturing, but one of the most important is the use of a solid “proppant” in the fracturing fluid to keep the strata cracks open as oil, gas, water and other fluids found in well flow through those cracks. While a fracture may be created by fluid pressure, many times the formation pressure will urge the fracture to close partially if not wholly once the fracturing pressure is released. The problem of the fracture closing is solved by use of the proppant. Basically, the proppant is carried into the well with the fracturing fluid. The genius of using proppants is that once the fluid pressure is released, the proppants are left behind in the fracture, and when the formation pressure starts to urge the fracture to close, the proppants keep the fracture “propped” open.

Proppants can be made of virtually any generally solid particle that has a sufficiently high crush strength to prop open cracks in a rock strata at great depth and temperatures of about 35 C and higher. Sand and ceramic proppants have proved to be especially suitable for commercial use.

A proppant that is flushed from the well is said to have a high “flow back” which is undesirable. In addition to closure of the cracks, the flushed proppants are abrasive and can damage or clog the tubular goods used to complete the well, valves and pipelines in downstream processing facilities.

Additionally, during hydraulic fracturing propping agent particles under high closure stress tend to fragment and disintegrate. At closure stresses above about 5000 psi silica sand, the most common proppant, is not normally employed due to its propensity to disintegrate. The resulting fines from this disintegration migrate and plug the interstitial flow passages in the propped interval. These migratory fines drastically reduce the permeability of the propped fracture.

Proppants are coated to mitigate proppant flowback after a fracturing treatment, and to increase resistance against disintegration.

To improve the proppants, it is not unusual to coat the proppants with a resin. Generally, the outer surfaces of the resin-coated proppants have an adherent resin coating so that the proppant grains can be bonded to each other under suitable conditions forming a permeable barrier. The substrate materials for the resin-coated proppants include sand, glass beads, aluminum pellets, and organic materials such as shells or seeds. Non-limiting examples of resins used to coat proppants include alkyl resins, epoxy resins, furane resins, furfuryl alcohol resins, phenol-aldehyde resins, phenol resins, polyester resins, polyurethane-phenol resin, and urea-aldehyde resins. The resins can be in pure form or mixtures containing curing agents, coupling agents or other additives. Different binding agents have been used. To reduce the proppant flowback, the resin coated proppants are pumped into the near-wellbore formation in the last portion of the sand stage to form a permeable barrier.

The resin-coated proppants can be either partially cured, pre-cured or can be cured by an overflush of a chemical binding agent, commonly known as activator, which often contains a surfactant.

With some coatings, the synthetic coating is not completely cured when the proppant is introduced into the well. The coated, partially-cured proppants are free flowing, but the coating resin is still slightly reactive. The final cure is intended to occur in situ in the strata fracture at the elevated closure pressures and temperatures found “down hole.”

Other coatings are described as being pre-cured or tempered. In this case the coating is essentially cured during the manufacturing process. This type of coating will strengthen the substrate particle so that it can withstand a higher stress level before grain failure. Such a pre-cured coating with also exhibit the following traits: (1) Excellent storage stability; (2) Minimal chemicals that can be leached out of the coating to interfere with carrier fluid viscosity or breaker systems; and (3) A coating that is resilient to the abrasion of pneumatic handling.

To increase their resistance against disintegration, sand particles are coated with infusible resins such as an epoxy or phenolic resin. Although these materials show significant resilience against disintegration, the resin coated sand particles still show decrease in permeability to about the same degree as silica sand especially at higher closure stresses and lower temperatures, up to 225 F. One reason for such decrease in permeability is resin's unsuitable plasticity and unsuitable viscosity for coatings. Another cause for reduction in permeability is the delaminating of resin layer from the silica surface. Normally, a silane coupling agent is employed prior to the application of infusible resin to minimize the resin delaminating. In addition, energy consumption due to high coating temperatures; release of toxins and byproducts such as phenol, formaldehyde, bisphenol A, epichlorohydrin, and isocyanatcs; and inconsistent and very high viscosities of resins, are some of the drawbacks of resin coatings Another problem associated with resin coating process is the use of external cross-linkers, which in the case of phenolic novolac resin is hexamethylenetetramine (HEXA). It presents several health and environmental dangers.

Although numerous different types of resins have been utilized to coat proppant sand, phenol-formaldehyde resins still dominate the resin coated sand applications. All other types of resins known to those familiar in the art have exhibited inferior performance as compared to phenol-formaldehyde resins, evidenced by decrease in permeability and conductivity of the proppant pack. Phenol-formaldehyde resins have historically been used in coating sands that are used in the production of metal castings by a process called shell mold process. In that process, a heated die is charged with resin coated sand to form a casting. In early 1980s, the hydraulic fracturing industry needed proppant particles that could form a consolidated pack in the subterranean formations to prevent the proppant from flowing back with the hydrocarbon. Those familiar with the challenge at the time addressed the problem by bringing the sand coated for shell molding into hydraulic fracturing application, not realizing that the two applications were very different from each other. Although self-consolidating sands proved satisfactory in numerous applications to control proppant flowback, their ability to provide a permeable and conductive path is still questionable, especially at higher closure stresses and temperature. Although many improvements and attempts to improvement have been made to phenolic resins and sand coating processes to make phenolic resins more compatible to coat sand substrates, still there is no resin available in the industry to claim full compatibility to coat fracturing sand substrates.

In the case of poor or even average adhesion between the resin and a sand grain, when resin coated sand is subjected to closure stresses of over 8000 psi and temperature of over 125 F, the resin starts to slide off of the silica substrate and starts to migrate and reside in the pore spaces of the proppant pack which introduces a resistance in the flow path of the hydrocarbon. Coating companies utilize external coupling agents, commonly silane coupling agents, to deal with this resin deficiency.

Due to their higher molecular weights and highly random structures, phenolic and other infusible resins exhibit very high melt viscosities which prevent them from flowing into the natural fractures and crevices of the sand particles. This problem is compounded by reaction of resin with its cross-linker. As the resin cross-links, its viscosity increases drastically. The gap between the resin coat and “valley” on a sand grain introduces a plane of weakness in the coating. Therefore, even at low closure stresses, the resin coat fractures and expose the silica surface to the fluid passing around the grain. As soon as the silica surface is exposed, the formation fluids, especially brines, penetrate into the interface between the resin and the sand substrate which causes the resin to detach from the surface of the sand, even if a coupling agent has been employed.

Phenolic or other resins with the ability to cross-link undergo different stages of plastic behavior before reaching their ultimate infusible state. Coating companies b-stage resins to achieve a level of plasticity that can help a resin advance in cure to generate grain-to-grain bonding. It is very difficult to control the level or b-staging. In many cases, a resin is falsely assumed to reach its infusible state; it shows plastic or deformable behavior which has significant effect on reducing the conductivity of proppant pack.

Resins that are typically used in coating sand proppants require coating temperatures ranging from at least about 385 F to 450 F or higher to crosslink. While some resole resins may be applied as low as 300 F, it is noted that they are B-staged and not fully crosslinked until about 400 F. Such high temperatures lead to higher energy demand and release of volatile fumes into the environment. Phenolic resins release phenols, substituted phenols, and phenolic oligomers upon contact with hot sand. In addition, because they require hexamethylenetetramine as a cross-linker, a significant amount of know n carcinogen formaldehyde is released during the coating process.

The following are merely a few of the many patent publications and patents directed to proppants, coated proppants and proppant coatings.

U.S. Pat. No. 4,879,181, issued Nov. 7, 1989, to Fitzgibbon discloses sintered, spherical composite pellets or particles comprising one or more clays as a major component and bauxite, alumina, or mixtures thereof, are described, along with the process for their manufacture. The pellets may have an alumina-silica (Al2O3-SiO2) ratio from about 9:1 to about 1:1 by weight. The use of such pellets in hydraulic fracturing of subterranean formations is also described.

U.S. Pat. No. 5,120,455, issued Jun. 9, 1992 to Lunghofer, discloses a high strength propping agent for use in hydraulic fracturing of subterranean formations comprising solid, spherical particles having an alumina content of between 40 and 60%, a density of less than 3.0 gm/cc and an ambient temperature permeability of 100,000 or more millidarcies at 10,000 psi.

U. S. Patent Application No. 20030224165, published Dec. 4, 2003, by Anderson et al., discloses coated particulate matter wherein the particles are individually coated with a first set of one or more layers of a curable resin, for example, a combination of phenolic/furan resin or furan resin or phenolic-furan-formaldehyde terpolymer, on a proppant such as sand, and the first set of layers is coated with a second set of one or more layers of a curable resin, for example, a novolac resin with curative. Methods for making and using this coated product as a proppant, gravel pack and for sand control are also disclosed.

U.S. Patent Application No. 20050059555, published Mar. 17, 2005, by Dusterhoft et al., discloses methods and compositions for stabilizing the surface of a subterranean formation using particulates coated with a consolidating liquid. One embodiment of the present invention provides a method of fracturing a subterranean formation, comprising providing a fracturing fluid comprising proppant particulates at least partially coated with a hardenable resin composition that comprises a hardenable resin component and a hardening agent component, wherein the hardenable resin component comprises a hardenable resin and wherein the hardening agent component comprises a hardening agent, a silane coupling agent, and a surfactant; introducing the fracturing fluid into at least one fracture within the subterranean formation; depositing at least a portion of the proppant particulates in the fracture; allowing at least a portion of the proppant particulates in the fracture to form a proppant pack; and, allowing at least a portion of the hardenable resin composition to migrate from the proppant particulates to a fracture face.

U.S. Patent Application No. 20050230111, published Oct. 20, 2005, by Nguyen et al., discloses improved methods and compositions for consolidating proppant in subterranean fractures. In certain embodiments, the hardenable resin compositions may be especially suited for consolidating proppant in subterranean fractures having temperatures above about 200 F. Improved methods include providing proppant particles coated with a hardenable resin composition mixed with a gelled liquid fracturing fluid, and introducing the fracturing fluid into a subterranean zone. The fracturing fluid may form one or more fractures in the subterranean zone and deposit the proppant particles coated with the resin composition therein. Thereafter, the hardenable resin composition on the proppant particles is allowed to harden by heat and to consolidate the proppant particles into degradation resistant permeable packs. The hardenable resin composition may include a liquid bisphenol A-epichlorohydrin resin, a 4,4′-diaminodiphenyl sulfone hardening agent, a solvent, a silane coupling agent, and a surfactant. The solvent may include diethylene glycol monomethyl ether or dimethyl sulfoxide.

U.S. Patent Application No. 20080103067, published May 1, 2008, by Schmidt et al., discloses a process for preparing hydrolytically and hydrothermally stable, consolidated proppants, in which (A) a consolidant comprising a hydrolyzate or precondensate of at least one organosilane, a further hydrolyzable silane and at least one metal compound, where the molar ratio of silicon compounds used to metal compounds used is in the range from 10 000:1 to 10:1, is blended with a proppant or infiltrated or injected into the geological formation, and (B) the consolidant is cured under conditions of elevated pressure and elevated temperature.

U.S. Patent Application No. 20090264323, published Oct. 22, 2009, by Altherr et al., discloses a process for the preparation of hydrolytically and hydrothermally stable consolidated proppants, in which (A) a consolidating agent comprising (Al) a hydrolysate or precondensate of at least one functionalized organosilane, a further hydrolyzable silane and at least one metal compound, the molar ratio of silicon compounds used to metal compounds used being in the range of 10 000:1 to 10:1, and (A2) an organic crosslinking agent are mixed with a proppant and (B) the consolidating agent is cured at elevated pressure and elevated temperature. The consolidated proppants obtained have high mechanical strength.

U.S. Patent Application No. 20100179077, published Jul. 15, 2010, by Turakhia, discloses a coated proppant comprising a proppant particulate substrate and a toughened epoxy resin composition coating layer on the substrate. The coating layer is formed from a composition comprising a resin, a curing agent, an adhesion promoter, and a toughening agent.

U.S. Patent Application No. 20100212898, published Aug. 26, 2010, by Nguyen et al., discloses methods and compositions for consolidating particulate matter in a subterranean formation in one embodiment, a method of treating a subterranean formation includes coating a curable adhesive composition comprising a silane coupling agent and a polymer having a reactive silicon end group onto proppant material; suspending the coated proppant material in a carrier fluid to form a proppant slurry; introducing the proppant slurry into a subterranean formation; and allowing the curable adhesive composition to at least partially consolidate the proppant material in the subterranean formation.

U.S. Patent Application No. 20100256024, published Oct. 7, 2010, by Zhang discloses a resin coated proppant slurry and a method for preparing a slurry where the resin coated proppant particles are rendered less dense by attaching stable micro-bubbles to the surface of the resin coated proppants. A collector or frother may be added to enhance the number or stability of bubbles attached to the proppants. This method and composition finds use in many industries, especially in oil field applications.

U.S. Patent Application No. 20100276142, published Nov. 4, 2010, by Skildum et al., discloses a method of treating proppant particles present in a fractured subterranean geological formation comprising hydrocarbons in-situ with fluorinated silane.

U.S. Patent Application 20120283153, published Nov. 8, 2012, by McDaniel et al., discloses solid proppants are coated with a coating that exhibits the handling characteristics of a precured coating while also exhibiting the ability to form particle-to-particle bonds at the elevated temperatures and pressures within a wellbore. The coating includes a substantially homogeneous mixture of (i) at least one isocyanate component having at least 2 isocyanate groups, and (ii) a curing agent. The coating process can be performed with short cycle times, e.g., less than about 4 minutes, and still produce a dry, free-flowing, coated proppant that exhibits low dust characteristics during pneumatic handling but also proppant consolidation downhole for reduced washout and good conductivity.

U.S. Patent Application No. 20130065800, published Mar. 14, 2013, by McDaniel et al., discloses solid proppants coated with a coating that exhibits the handling characteristics of a pre-cured coating while also exhibiting the ability to form particle-to-particle bonds at the elevated temperatures and pressures within a wellbore. The coating includes a substantially homogeneous mixture of (i) at least one isocyanate component having at least 2 isocyanate groups, and (ii) a curing agent comprising a monofunctional alcohol, amine or amide. The coating process can be performed with short cycle times, e.g., less than about 4 minutes, and still produce a dry, free-flowing, coated proppant that exhibits low dust characteristics during pneumatic handling but also proppant consolidation downhole for reduced washout and good conductivity. Such proppants also form good unconfined compressive strength without use of an bond activator, are substantially unaffected in bond formation characteristics under downhole conditions despite prior heat exposure, and are resistant to leaching with hot water.

U.S. Patent Application No. 20130186624, published Jul. 25, 2013 to McCrary, discloses solid proppants coated in a process that includes the steps of: (a) coating free-flowing proppant solids with a first component of either a polyol or an isocyanate in mixer; (b) adding a second component of either an isocyanate or a polyol that is different from the first component at a controlled rate or volume sufficient to form a polyurethane coating on the proppant solids; and (c) adding water at a rate and volume sufficient to retain the free-flowing characteristics of the proppant solids.

U.S. Patent Application No. 20130225458 published Aug. 29, 2013, by Qin et al., discloses a hydrophobic proppant and a preparation method thereof. The aggregate particles of the hydrophobic proppant are coated with a coating resin which comprises a hydrophobic resin and nano-particles which are uniformly distributed in the coating resin and constitute 5-60% of the coating resin by weight. The contact angle labeled as θ between water and the hydrophobic proppant in which nano-particles are added is in the range of 120°≦θ≦180°. The proppant of the present invention is prepared by adding the nano-particles in the existing resin in which low-surface-energy substances with hydrophobic groups are added, and a rough surface with a micro-nano structure is constructed on the outer surface of the prepared resin film, so that the contact angle .theta. at the solid-liquid contact surface on the outer surface of the coating resin of the proppant is more than 120.degree. Embodiment 5 discloses a coating resin for quartz sand that comprises a hydrophobic resin and nano-particles, wherein the hydrophobic resin is obtained by modifying a phenolic resin with tricarboxylic polydimethylsiloxane.

In spite of the advances in the prior art, there is still a need in the art for proppant coatings, for coated proppants, for well fluids comprising such coated proppants, for methods of making and using said coatings, proppants and well fluids, for methods of fracturing a well with said proppants and well fluids, and for a well comprising such proppants and well fluids.

These and other needs in the art will become apparent to those of skill in the art upon review of this specification, including its drawings and claims.

### SUMMARY OF THE INVENTION

In contrast to the prior art method of first coating proppants with a silane coupling agent followed by a resin coating and high temperature curing, the present invention, utilizes a silane coating pre-coupled with a resin and a much lower processing temperature. The resulting coated proppant has improved properties and may be utilized as a proppant, or may be treated as a proppant precursor and further coated with a silane coupling agent, followed by a resin coating to provide an even further improved coating. It is an object of the present invention to provide for proppant coatings, for coated proppants, for well fluids comprising such coated proppants, for methods of making and using said coatings, proppants and well fluids, for methods of fracturing a well with said proppants and well fluids, and for a well comprising such proppants and well fluids.

The present invention includes a number of coating compositions as described herein. The present invention also includes methods of making those various coating compositions. The present invention also includes coated products comprising substrates coated by the various coating compositions. The present invention also includes methods of making those coated products. The present invention also includes slurries comprising the coated products and a liquid, with such slurries having utility in hydraulic fracturing among other uses. The present invention also includes methods of making those slurries. The present invention also includes methods of operating a well comprising circulating a well fluid comprising coated products as described herein. The present invention also includes a method of hydraulic fracturing utilizing the coated products described herein.

These and other objects of the present invention will become apparent to those of skill in the art upon review of this specification, including its drawings and claims.

According to one embodiment of the present invention, there is provided a proppant comprising a substrate containing silicon and a silane coating. The coating includes a central silicon atom, a first L atom directly bonded to the central silicon atom to create an Si-L linkage, a prepolymer that is bonded directly the central silicon atom or bridged to the central silicon atom by a second L atom directly bonded to the central silicon atom to create an Si-L-prepolymer linkage. Additionally, the silicon in the substrate is bonded directly to the first L atom to form an Si-L-Si linkage between the silicon in the substrate and the central silicon atom in the coating. Finally, L is selected from the group consisting of boron (B), nitrogen (N), oxygen (O), phosphorus (P) and sulphur (S).

According to another embodiment of the present invention, there is provided a proppant comprising:
a substrate containing silicon; and,
a coating composition comprising:

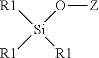

wherein Si is silicon with 3 pendant groups R1, wherein the R1 groups may be the same or different; wherein at least one R1 comprises R2 or —O—R2, wherein O is oxygen and R2 is a crosslinkable prepolymer; wherein at least one R1 comprises —O—R3, wherein O is as defined above and; wherein the remaining R1 comprise R5, wherein R5 is selected from among H, —O—R2, —O—R3, or —R4, where R2 is as defined above, R3 is selected from among H or —R4OH, wherein H is hydrogen, and R4 is a substituted or unsubstituted hydrocarbon group; and, wherein each of R2, R3, R4 and R5 are independently selected so that each R1 may be the same or different, and wherein Z represents the position that the silicon in the substrate bonds to O of the composition.

According to still another embodiment of the present invention, there is provided a proppant comprising:
a substrate containing silicon; and,
a coating composition comprising:

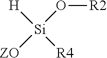

wherein R2 is a crosslinkable prepolymer, wherein R4 is a substituted or unsubstituted hydrocarbon group, and wherein Z represents the silica in the substrate bonding to O of the composition.

According to yet another embodiment of the present invention, there is provided a method of making a proppant comprising contacting a substrate containing silicon with a silane coating. The silane coating comprises a central silicon atom, a first L atom directly bonded to the central silicon atom to create an Si-L linkage, a prepolymer that is bonded directly the central silicon atom or bridged to the central silicon atom by a second L atom directly bonded to the central silicon atom to create an Si-L-prepolymer linkage. L is selected from the group consisting of boron (B), nitrogen (N), oxygen (O), phosphorus (P) and sulphur (S). The method forms a proppant in which the silicon in the substrate is bonded directly to the first L atom in the coating to form an Si-L-Si linkage between the silicon in the substrate and the central silicon atom in the coating.

According to even still another embodiment of the present invention, there is provided a method of making a proppant comprising contacting a substrate containing silicon with a coating composition. The coating composition comprises:

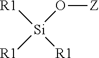

wherein Si is silicon with 3 pendant groups R1, wherein the R1 groups may be the same or different; wherein at least one R1 comprises R2 or —O—R2, wherein O is oxygen and R2 is a crosslinkable prepolymer; wherein at least one R1 comprises —O—R3, wherein O is as defined above and; wherein the remaining R1 comprise R5, wherein R5 is selected from among H, —O—R2, —O—R3, or —R4, where R2 is as defined above, R3 is selected from among H or —R4OH, wherein H is hydrogen, and R4 is a substituted or unsubstituted hydrocarbon group; and, wherein each of R2, R3, R4 and R5 are independently selected so that each R1 may be the same or different.
   The method form a proppant in which Z represents the position that the silicon in the substrate bonds to O of the coating composition.

According to even yet another embodiment of the present invention, there is provided a method of making a proppant comprising contacting a substrate containing silicon with a coating composition. The coating composition comprises:

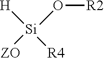

wherein R2 is a crosslinkable prepolymer, wherein R4 is a substituted or unsubstituted hydrocarbon group.
   The method forms a proppant in which Z represents the position that silicon in the substrate bonds to O of the composition.

According to still even another embodiment of the present invention, there is provided a hydraulic fracturing fluid comprising a liquid portion and proppants dispersed in the liquid portion. At least some of the proppants comprise a substrate containing silicon and a silane coating. The silane coating includes a central silicon atom, a first L atom directly bonded to the central silicon atom to create an Si-L linkage, a prepolymer that is bonded directly the central silicon atom or bridged to the central silicon atom by a second L atom directly bonded to the central silicon atom to create an Si-L-prepolymer linkage. The silicon in the substrate is bonded directly to the first L atom to form a Si-L-Si linkage between the silicon in the substrate and the central silicon atom in the coating. L is selected from the group consisting of boron (B), nitrogen (N), oxygen (O), phosphorus (P) and sulphur (S).

According to still yet another embodiment of the present invention, there is provided a hydraulic fracturing fluid comprising a liquid portion and proppants dispersed therein. At least some of the proppants comprises a substrate containing silicon and a coating composition comprising:

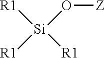

wherein Si is silicon with 3 pendant groups R1, wherein the R1 groups may be the same or different; wherein at least one R1 comprises R2 or —O—R2, wherein O is oxygen and R2 is a crosslinkable prepolymer; wherein at least one R1 comprises —O—R3, wherein O is as defined above and; wherein the remaining R1 comprise R5, wherein R5 is selected from among H, —O—R2, —O—R3, or —R4, where R2 is as defined above, R3 is selected from among H or —R4OH, wherein H is hydrogen, and R4 is a substituted or unsubstituted hydrocarbon group; and, wherein each of R2, R3, R4 and R5 are independently selected so that each R1 may be the same or different, and wherein Z represents the position that the silicon in the substrate bonds to O of the composition.

According to yet even another embodiment of the present invention, there is provided a hydraulic fracturing fluid comprising a liquid portion and proppants therein. At least a portion of the proppants comprise a substrate containing silicon and a coating composition. The coating composition comprises:

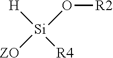

wherein R2 is a crosslinkable prepolymer, wherein R4 is a substituted or unsubstituted hydrocarbon group, and wherein Z represents the position wherein the silicon in the substrate bonds to O of the composition.

According to yet still another embodiment of the present invention, there is provided a method of hydraulically fracturing a subterranean formation penetrated by a wellbore, comprising: forcing fracturing fluid into the wellbore at a sufficient pressure so that the fracturing fluid forms fractures in the subterranean formation, and releasing the pressure and allowing at least a portion of the proppant to remain in the fractures in the subterranean formation. At least some of the proppants comprise a substrate containing silicon and a silane coating. The coating includes a central silicon atom, a first L atom directly bonded to the central silicon atom to create an Si-L linkage, a prepolymer that is bonded directly the central silicon atom or bridged to the central silicon atom by a second L atom directly bonded to the central silicon atom to create an Si-L-prepolymer linkage. The silicon in the substrate is bonded directly to the first L atom to form an Si-L-Si linkage between the silicon in the substrate and the central silicon atom in the coating. L is selected from the group consisting of boron (B), nitrogen (N), oxygen (O), phosphorus (P) and sulphur (S).

According to even still yet another embodiment of the present invention, there is provided a method of hydraulically fracturing a subterranean formation penetrated by a wellbore, comprising: forcing fracturing fluid into the wellbore at a sufficient pressure so that the fracturing fluid forms fractures in the subterranean formation, and releasing the pressure and allowing at least a portion of the proppant to remain in the fractures in the subterranean formation. At least a portion of the proppant comprises:
a substrate containing silicon; and,
a coating composition comprising:

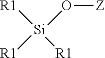

wherein Si is silicon with 3 pendant groups R1, wherein the R1 groups may be the same or different; wherein at least one R1 comprises R2 or —O—R2, wherein O is oxygen and R2 is a crosslinkable prepolymer; wherein at least one R1 comprises —O—R3, wherein O is as defined above and; wherein the remaining R1 comprise R5, wherein R5 is selected from among H, —O—R2, —O—R3, or —R4, where R2 is as defined above, R3 is selected from among H or —R4OH, wherein H is hydrogen, and R4 is a substituted or unsubstituted hydrocarbon group; and, wherein each of R2, R3, R4 and R5 are independently selected so that each R1 may be the same or different, and wherein Z represents the position that the silicon in the substrate bonds to O of the composition.

According to even yet still another embodiment of the present invention, there is provided a method of hydraulically fracturing a subterranean formation penetrated by a wellbore, comprising: forcing fracturing fluid into the wellbore at a sufficient pressure so that the fracturing fluid forms fractures in the subterranean formation, and releasing the pressure and allowing at least a portion of the proppant to remain in the fractures in the subterranean formation. At least a portion of the proppants comprise a substrate containing silicon and a coating composition. The composition comprises:

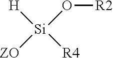

wherein R2 is a crosslinkable prepolymer, wherein R4 is a substituted or unsubstituted hydrocarbon group, and wherein Z represents the position wherein the silicon in the substrate bonds to O of the composition.

These and other embodiments of the present invention will become apparent to those of skill in the art upon review of this specification, including its drawings and claims.

### DETAILED DESCRIPTION OF THE INVENTION

In the practice of the present invention, coatings of the present invention are applied to substrates to provide coated substrates. These coated substrates are sometimes useful as it, or they may be treated as coated pre-cursor substrates and further contacted with a silane coupling agent, followed by a contact with a resin coating. Very commonly, the resin coating will comprise phenolic resins, that may or may not be precured or B-staged. As a non-limiting example, the coatings of the present invention may be applied to sand to provide improved sand useful as proppants in facturing operations, or such coated sand may be further contacted with a silane coupling agent, followed by a contact with a resin coating to provide an even more improved proppant.

The coating compositions of the present invention are silicon containing compounds having at least one Si-L linkage wherein Si is silicon and L is generally a non-metal atom with hypervalent properties. Non-limiting examples of atoms suitable as L include boron (B), nitrogen (N), oxygen (O), phosphorus (P) and sulphur (S). Many embodiments of the present invention will utilize oxygen (O) as L. A “siloxa linkage” is one that includes at least one oxygen bonded to silicon, as a non-limiting example, of the form “O—Si”, wherein Si is silicon and O is oxygen. As a non-limiting embodiment, some of these silane compounds having the described “Si-L” linkage may be obtained by hydrolyzing silane compounds, usually by hydrolyzing halo-silane compounds wherein the halogen appended to the silica is replaced by —BH₂, NH₂, —OH, —PH₂, or —SH, thus forming the “Si-L” linkage. It is this “Si-L” linkage that will bond with the coated substrate, particularly if the substrate also contains silicon resulting in a “Si-L-Si” linkage between the silicon of the coating and the silicon in the substrate. The coating compositions of the present invention will also include at least one prepolymer that in some embodiments is directly bonded to the silicon (i.e., Si-prepolymer), or that in other embodiments the silane compound includes a second Si-L linkage, with the prepolymer bridged to the silicon by this second L (i.e., Si-L-prepolymer). Prepolymers suitable for use in the present invention are cross-linkable, preferably cross-linkable even in the absence of catalyst or other cross-linking agent. These prepolymers may be monomers, oligomers (i.e., generally less than 10, 9, 8, 7, 6, 5, 4, or 3 monomers) or low molecular weight polymers. Preferably, the prepolymers are oligomers or low molecular weight polymers. Non-limiting examples of prepolymers suitable for use in the present invention include phenolics, urethanes, furanes, and ketones.

While the coatings of the present invention may be suitable for use in coating a wide variety of substrates, some of the embodiments of the present invention may be particularly useful for coating silicon containing substrates, most notably, sand, especially in the making of coated sand, and even more specifically making coated sand for use as hydraulic fracturing proppants.

In addition to the coatings and coating compositions of the present invention, various embodiments of the present invention include and are not limited to methods of making the coating compositions of the present invention, methods of coating substrates with the coating composition of the present invention, coated substrates of the present invention, proppants of the present invention, methods of using the coated substrates including methods of hydraulic fracturing, hydraulic fracturing fluids having coated substrates of the present invention, methods of making a fracturing fluid, fractured subterranean comprising proppants of the present invention, and wells comprising a circulating fracturing fluid comprising proppants of the present invention.

Fracturing proppants when coated or reinforced by some coatings of the present invention yield a more permeable mass at closure stresses higher than 2000 psi, 3000 psi, 4000 psi, 5000 psi, 6000 psi, 7000 psi, 8000 psi, 9000 psi, 10000 psi, 11000 psi, 12000 psi, 15000 psi, 20000 psi, or 30000 psi than fracturing sand proppants alone. It is believed that the coated proppants of the present invention are extremely suitable for use at closure stresses from/to or between any two of the following closures stresses: 2000 psi, 3000 psi, 4000 psi, 5000 psi, 6000 psi, 7000 psi, 8000 psi, 9000 psi, 10000 psi., such as for example from 4000 psi to 8000 psi. With some embodiments, fracturing sand particles coated with the coatings of the present invention provide more permeable passage than low cost resin coated proppants.

Some coating embodiments of the present invention have been specifically designed to coat silicon-containing substrates, including silica based substrates, by addressing the problems posed by phenolic and other types of infusible resins. Some coating embodiments of the present invention address one or more of adhesion, coating viscosity, plasticity, coating temperature, environmental, and cross-linking characteristics, to create full compatibility with silica substrates.

The coatings of the present invention have a chemical structure that eliminates the need for a coupling agent, and they will bond directly to the silica substrate.

In addition, the coating viscosity of the coatings of the present invention is low enough to allow the penetration of resin into the valleys, natural fractures, and crevices of the sand grains. Suitable coating viscosities at the coating temperature will be in the range from/to or between any two of the following viscosities 50 cp, 100 cp, 150 cp, 200 cp, 250 cp, 300 cp, 400 cp, 500 cp, 600 cp, 700 cp, 800 cp, 900 cp, 1000 cp. Very commonly, suitable coating viscosities will be in the range of about 100 cp to 300 cp. It should be understood that coating compositions that have viscosities that are probably too low, will in many embodiments quickly increase as the crosslinking polymer generally increases in viscosity to a suitable viscosity, and these coating compositions should be suitable. For viscosities that are somewhat on the high end, increased mixing rates can sometimes help, up to a point. Certainly, at some point the viscosity is too high to allow suitable penetration of resin into the valleys, natural fractures, and crevices of the sand grains.

As another advantage, while prior art coating compositions typically used in coating sand proppants require coating temperatures of at least 385 F to crosslink, embodiments of the coatings of the present invention may be applied and crosslinked at lower temperatures thus resulting in less or even no release of volatile organic compounds. The coating temperatures for the coatings of the present invention are less than 385 F.

The coatings of the present invention will now be discussed in terms of the embodiment in which L is oxygen. In the following formulas and discussion, it should be understood that every occurrence of “O” can easily be replaced by “L” or any of “B”, “N”, “P” or “S”. Certainly S has the same valence as “O” and the formulas should be consistent, however, “B”, “N” and “P” will include an additional appended group. The formulas can easily be converted by the addition of 1 more H and/or “R” groups to “B”, “N” and “P” if utilized. Thus, the following discussion while specific to the embodiment in which L is oxygen, is also believed to apply to the generic case of L or any of the specific cases where L is B, O, N, P, and/or S.

Some embodiments of the coating compositions of the present invention may be represented by the following Formula 1:

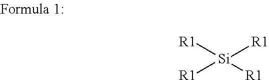

wherein Si is silicon with 4 pendant groups R1, wherein the R1 groups may be the same or different;
wherein at least one R1 comprises R2 or —O—R2, wherein O is oxygen and R2 is a crosslinkable prepolymer;
wherein at least one R1 comprises —O—R3, wherein O is as defined above and R3 is selected from among H or —R4OH, wherein H is hydrogen, and R4 is a substituted or unsubstituted hydrocarbon group;
wherein the remaining R1 comprise R5, wherein R5 is selected from among H, —O—R2, —O—R3, or —R4, where R2, R3 and R4 are as defined above; and,
wherein each of R2, R3, R4 and R5 are independently selected so that each R1 may be the same or different.

The prepolymers suitable for use as the R2 group in the present invention are cross-linkable, preferably cross-linkable even in the absence of catalyst or other cross-linking agent. These prepolymers may be monomers, oligomers (i.e., generally less than 10, 9, 8, 7, 6, 5, 4, or 3 monomers) or low molecular weight polymers. Preferably, the prepolymers are oligomers or low molecular weight polymers. Non-limiting examples of prepolymers types suitable for use in as R2 in the present invention include phenolics, urethanes, furanes, and ketones. As a non-limiting example, phenolic prepolymers are very useful for use as proppant coatings. As more particular non-limiting examples, bisphenols and epoxies derived from such bisphenols are suitable for use as prepolymers. Non-limiting examples of suitable bisphenols include bisphenol A, bisphenol AP, bisphenol AF, bisphenol B, bisphenol BP, bisphenol C, bisphenol E, bisphenol F, bisphenol G, bisphenol M, bisphenol S, bisphenol P, bisphenol PH, bisphenol TMC, bisphenol Z.

The prepolymer R2 group may connected to the silica (Si) by an oxygen bridge, or this prepolymer R2 group may be directly bonded to the silica. Bonding the prepolymer group R2 directly to silica generally requires use of a catalyst.

Hydrocarbon groups suitable for use as R4 above, may comprise in the range of about 1 to about 30 carbon atoms, and those carbon atoms may be linear, branched, and/or cyclic.

The crosslinkable prepolymers suitable for use in the present invention will have pre-crosslinked molecular weight less than 2000, 1500, 1000, 900, 800, 700, 600, 500, 400, 300, 200, 100 or in the range to/from or between any two of the foregoing numbers. It is believed that the higher the molecular weight, the more the silica/substrate bonding may be hindered. In fact, with some embodiments, this hindering may be noticed as low as molecular weights of 800 or 900, although it may not be considered too hindered. At some point, the molecular weight reaches the point where this bonding may become too hindered.

Non-limiting examples of suitable coating compositions include:

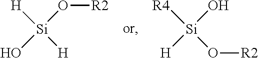

wherein, R2 is a crosslinkable prepolymer, and R4 is a substituted or unsubstituted linear, branched or cyclic hydrocarbon group. Non-limiting examples of suitable cyclic hydrocarbon groups include phenolic and cyclopentadienyl groups. Quite commonly the cyclic hydrocarbon groups may be substituted with hydrocarbon groups having 1 to 3 carbon atoms, and/or with —BH₂, —OH, —NH₂, —PH₂, or —SH. As non-limiting examples, R2 is a self-crosslinking phenolic prepolymer, and R4 is mono-phenol.

When coated on a substrate, the post-crosslinked molecular weight of the coating will be less than 20000, 10000, 9000, 8000, 7000, 6000, 5000, 4000, 3000, 2000, 1000, 500, 200 or in the range to/from or between any two of the foregoing numbers.

The coating methods of the present invention to form the coated products of the present invention generally include contacting the substrate to be coated with the coating composition of the present invention. The resulting coated product may be utilized as a coated product, or it may be treated a precursor with further coatings applied, for example the prior art siliane coupling agent followed by a resin.

The amount of coating applied should be enough to sufficiently coat the substrate but not to form too thick of a layer. The important issue is to bond coating to the substrate, not necessarily to bond more coating on top of coating. Certainly, there will be some amount of bonding of coating to coating. The amount of coating to be applied to a substrate will be in the range to/from or between any two of 5, 4, 3, 2, 1, 0.75, 0.5, 0.25, 0.1, 0.05 weight percent of coating by weight of the substrate.

With many embodiments of the present invention, the coatings may be applied at ambient temperatures. For those embodiments in which heating is required, the maximum crosslinking coating temperature will be less than 385 F, 350 F, 325 F, 300 F, 275 F, 250 F, 225 F, 200 F, 175 F, 150 F, 125 F, 100 F, 75 F, 50 F, or the maximum crosslinking coating temperature will be in the range between any two of the foregoing temperatures.

Any substrates are believed to be suitable for coating with the coating compositions of the present invention. The coatings of the present invention find great utility in application to silicon-containing substrates, including sand, as the idea is to “link” the silicon in the coating with the silicon in the substrate through “L” to form a Si-L-Si linkage. The coatings of the present invention may be applied to various substrates to form proppants, and these coatings may also be applied to known proppants, including both uncoated proppants and coated proppants, to form an improved proppant.

When the coated substrate is to be utilized as a proppant, the size of the substrate will commonly be in the mesh range of about to/from or between any two of on the following mesh sizes 1000, 800, 600, 400, 200, 100, 50, 25, 10, 8, 6, 4, 2 mesh, although depending upon the fracturing conditions/situation, larger or smaller substrates may be utilized as desired.

The coating compositions of the present invention are generally obtained by starting with a silane compound. This silane compound is then hydrolyzed to form a siloxane compound. The prepolymer is then added to the siloxane compound in the presence of an acid to yield the coating composition of the present invention.

The most useful silanes are halo-silanes, as the halogen is easily displaced in hydrolysis. In many instances, a silane is first halogenated to provide a halo-silane that is more useful in the practice of the present invention than a non-halogenated silane.

Non-limiting examples of silanes suitable for use in the present invention may be represented by the following Formula 2:

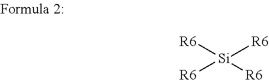

wherein Si is silicon with 4 pendant groups R6, wherein the R6 groups may be the same or different;
wherein at least one, preferably at least two R6 groups comprise —X, wherein X is a halogen selected from the group consisting of fluorine (F), chlorine (Cl), bromine (Br), iodine (I), and astatine (At);
the remaining R6 groups comprise H or R7 wherein H is hydrogen, and R7 is a substituted or unsubstituted hydrocarbon group; and,
wherein each of X and R7 is independently selected so that each R6 may be the same or different.

Suitable silanes may also be represented as RnSiX(4-n). The X functional group is involved in the reaction with the inorganic substrate. The bond between X and the silicon atom is replaced by a bond between the inorganic substrate and the silicon atom. X is a hydrolyzable group, typically, alkoxy, acyloxy, amine, or halogen (as described above). The most common alkoxy groups are methoxy and ethoxy, which give methanol and ethanol as byproducts during coupling reactions. R is a nonhydrolyzable organic radical that possesses a functionality which enables the coupling agent to bond with organic resins and polymers. Some embodiments of the present invention will utilize organosilanes that have one organic substituent.

Non-limiting examples of suitable silanes include, mono- di-, tri-, and tert-halosilanes, examples of which include dichlorosilanes and trichlorosilanes. Of course, the “halo” can be any halogen as described above, and the halogens appended to a particular silica may be the same or different. While tri- and tert-halosilanes may be utilized they are believed to less stable than their di- and mono-halo counterparts. Most embodiments will utilize dihalosilanes. Non-limiting specific examples of suitable silanes include dichlorosilane, monophenoldichlorosilane, and diphenolmonochlorosilane.

Suitable silanes may also be selected from among epoxy silanes, methacryloxy silanes, acryloxy silanes, amino silanes, isocyanurate silanes, ureide silanes, mercapto silanes, sulfide silanes, isocyanate silanes. Non-limiting examples of other suitable silanes include 2-(3,4 epoxycyclohexyl) ethyltrimethoxysilane; 3-Glycidoxypropyl trimethoxysilane; 3-Glycidoxypropyl methyldiethoxysilane; 3-Glycidoxypropyl triethoxysilane; 3-Methacryloxypropyl methyldimethoxysilane; 3-Methacryloxypropyl trimethoxysilane; 3-Methacryloxypropyl methyldimethoxysilane; 3-Methacryloxypropyl triethoxysilane; 3-Acryloxypropyl trimethoxysilane; N-2-(Aminoethlyl)-3-aminopropylmethyldimethoxysilane; N-2-(Aminoethlyl)-3-aminopropyltrimethoxysilane, 3-Aminopropyltrimethoxysilane; 3-Aminopropyltriethoxysilane; Partially hydrolyzates of 3-Triethoxysily-N-(1,3 dimethyl-butylidene) propylamine; N-Phenyl-3-aminopropyltrimethoxysilane; N-(Vinylbenzyl)-2-aminoethyl-3-aminopropyltrimethoxysilane hydrochloride; N-(Vinylbenzyl)-2-aminoethyl-3-aminopropyltrimethoxysilane hydrochloride, hydrolysate; Tris-(trimethoxysilylpropyl)isocyanurate; 3-Ureidopropyltriethoxysilane; 3-Mercaptopropylmethyldimethoxysilane; 3-Mercaptopropyltrimethoxysilane; Bis(Triethoxysilylpropyl)tetrasulfide; and 3-lsocyanatepropyltriethoxysilane.

In the practice of the present invention, hydrolyzing the silane will substitute —BH₂, NH₂, —OH, —PH₂, or —SH) for the halogens, or other appended groups While it can be carried out at higher temperatures, this hydrolysis is very commonly carried out at a temperature less than about 280 F, for example in the range from about ambient to less than 280 F. As a non-limiting example, the dichlorosilane and monophenoldichlorosilane mentioned above will become dihydroxysilane and monophenoldihydroxysilane, respectively.

This hydrolyzed silane is then contacted with the prepolymer in the presence of an acid to form the coating composition of the present invention. This prepolymer is commonly added at a temperature that is hot enough to allow for a fast enough bonding of the prepolymer, but not too high as to overly crosslink the prepolymer. Very commonly, this temperature will be in the range of about 225 F plus or minus 25 F.

The present invention is not limited the acids listed below. It is believed that any acid suitable to allow the bonding of the prepolymer to the hydrolyzed silane is suitable for use in the present invention. Non-limiting examples of acids suitable for use in the addition of the prepolymer include acids such as HCl (hydrochloric acid), HNO3 (nitric acid), H2SO4 (sulfuric acid), HBr (hydrobromic acid), HI hydroiodic acid, HClO4 (perchloric acid), CH3COOH (acetic acid), HCOOH (formic acid), HF (hydrofluoric acid), HCN (hydrocyanic acid), HNO2 (nitrous acid), and HSO4-(hydrogen sulfate ion).

The proppants of the present invention comprising the coatings of the present invention may be useful as a propping agent in methods of fracturing subterranean formations to increase the permeability thereof. While the proppants of the present invention are believed to be useful in almost any type of formation, these proppants will find particular utility in those formations at depths greater than 2000 ft, 4000 ft, 6000 ft, 8000 ft, 10000 ft, 12000 ft, 14000 ft, 15000 ft, 20000, and 30000 ft. As a non-limiting example, the proppants of the present invention will find utility at depths in the range to/from or between any two of the following depths 2000 ft, 4000 ft, 6000 ft, 8000 ft, 10000 ft, 12000 ft, 14000 ft, 15000 ft, 20000 ft., and 30000 ft. While there is no set upper limit of formation depth at which the present invention proppants may be utilized, certainly at some point formation pressures will reduce the performance characteristics. Additionally, various coating composition embodiments will have different suitable formation depths depending upon the particular chemical composition of the coating, and the extent to which it is crosslinked.

In general, the hydraulic fracturing of subterranean formations may include making a hydraulic fracturing fluid that is a slurry of an aqueous fluid and the proppant. The hydraulic fluid is injected into the subterranean formation under pressure that causes the formation to fracture. Once the pressure is removed and the fluid retreats, proppant is left in the fracture to prop open the fracture.

When used as a propping agent, the coated products of the present invention may be handled in the same manner as other propping agents. The pellets may be delivered to the well site in bags or in bulk form along with the other materials used in fracturing treatment, and while possible to be delivered in a slurry form that is not common and usually not economical.

As a quick overview of hydraulic fracturing, a viscous fluid, frequently referred to as “pad”, is injected into the well at a rate and pressure to initiate and propagate a fracture in the subterranean formation. The fracturing fluid may be an oil base, water base, acid, emulsion, foam, or any other fluid. Injection of the fracturing fluid is continued until a fracture of sufficient geometry is obtained to permit placement of the propping pellets. Thereafter, the proppants of the present invention as hereinbefore described are placed in the fracture by injecting into the fracture a fluid into which the pellets have previously been introduced and suspended. The propping distribution is usually, but not necessarily, a multi-layer pack. Following placement of the proppants of the present invention, the well is shut-in for a time sufficient to permit the pressure in the fracture to bleed off into the formation. This causes the fracture to close and apply pressure on the proppants which resist further closure of the fracture.

The hydraulic fracture is formed by pumping the fracturing fluid into the wellbore at a rate sufficient to increase pressure downhole at the target zone (determined by the location of the well casing perforations) to exceed that of the fracture gradient (pressure gradient) of the rock. The fracture gradient is defined as the pressure increase per unit of the depth due to its density and it is usually measured in pounds per square inch per foot or bars per meter. The rock cracks and the fracture fluid continues further into the rock, extending the crack still further, and so on. Fractures are localized because of pressure drop off with frictional loss, which is attributed to the distance from the well. In the practice of the present invention, it may be necessary to maintain “fracture width”, or slow its decline, following treatment by introducing into the injected fluid the proppant of the present invention, to prevent the fractures from closing when the injection is stopped and the pressure of the fluid is removed. This propped fracture is permeable enough to allow the flow of formation fluids to the well. In the practice of the present invention, non-limiting examples of formation fluids may include gas, oil, salt water and fluids introduced to the formation during completion of the well during fracturing.

The proppants and fracturing methods of the present invention will find utility in all sorts of wells, including but not limited to the hydraulic fracturing of vertical wells and horizontal wells. The proppants and fracturing methods of the present invention may also find utility in already highly permeable reservoirs such as sandstone-based wells, in a technique known as “well stimulation”.

In addition to containing the proppants of the present invention, the fracturing fluids of the present invention may include a number of additives. When this high-pressure fracture fluid is injected into the wellbore, with the pressure above the fracture gradient of the rock, the main purposes of fracturing fluid may be to extend fractures, add lubrication, change gel strength and to carry the proppant of the present invention into the formation, the purpose of which is to stay there without damaging the formation or production of the well. Commonly, as non-limiting examples, one of two method of transporting the proppant in the fluid are used—high-rate and high-viscosity. High-viscosity fracturing tends to cause large dominant fractures, while high-rate (slickwater) fracturing causes small spread-out micro-fractures. This fracture fluid contains water-soluble gelling agents (such as guar gum) which increase viscosity and efficiently deliver the proppant into the formation.

In the practice of the present invention, the fracturing fluid may comprise a number of chemical additives, non-limiting examples of which include gels, foams, and compressed gases, including nitrogen, carbon dioxide and air can be injected. It is not uncommon for a fracturing fluid to comprise 90% water and 9.5% proppant, with the chemical additives accounting to about 0.5%. There are fracturing fluids that utilize other materials to replace some or all of the aqueous portion, such as liquefied petroleum gas (LPG) and propane.

Of course, the fluid(s) selected for use in the fracturing fluid necessitate tradeoffs in such material properties as viscosity, where more viscous fluids can carry more concentrated proppant; the energy or pressure demands to maintain a certain flux pump rate (flow velocity) that will conduct the proppant appropriately; pH, various rheological factors, among others. In addition to the proppants of the present invention, some embodiments anticipate mixtures of proppants that include the proppants of the present invention, and one or more other types of proppants, non-limiting examples of which may include uncoated sand, coated sand (different coating than the ones of the present invention), ceramics.

The fracturing fluid of the present invention may in composition depending on the type of fracturing used, the conditions of the specific well being fractured, and the water characteristics. Very commonly, a typical fracture treatment may include on or more of the following additive chemicals. Although there may be unconventional fracturing fluids, it would not be uncommon for the fracturing fluids of the present invention to include one or more of the following:
Acids—hydrochloric acid or acetic acid is used in the pre-fracturing stage for cleaning the perforations and initiating fissure in the near-wellbore rock.
Sodium chloride (salt)—delays breakdown of the gel polymer chains.
Polyacrylamide and other friction reducers—Decrease turbulence in fluid flow decreasing pipe friction, thus allowing the pumps to pump at a higher rate without having greater pressure on the surface.
Ethylene glycol—prevents formation of scale deposits in the pipe.
Borate salts—used for maintaining fluid viscosity during the temperature increase.
Sodium and potassium carbonates—used for maintaining effectiveness of crosslinkers.
Glutaraldehyde—used as disinfectant of the water (bacteria elimination).
Guar gum and other water-soluble gelling agents—increases viscosity of the fracturing fluid to deliver more efficiently the proppant into the formation.
Citric acid—used for corrosion prevention.
Isopropanol—increases the viscosity of the fracture fluid.
Methanol.
2-butoxyethanol.
Conventional linear gels, such as cellulose derivatives (carboxymethyl cellulose, hydroxyethyl cellulose, carboxymethyl hydroxyethyl cellulose, hydroxypropyl cellulose, methyl hydroxyl ethyl cellulose), guar or its derivatives (hydroxypropyl guar, carboxymethyl hydroxypropyl guar)-based, with other chemicals providing the necessary chemistry for the desired results.
Borate-crosslinked fluids, such as guar-based fluids cross-linked with boron ions (from aqueous borax/boric acid solution). These gels have higher viscosity at pH 9 onwards and are used to carry proppants. After the fracturing job the pH is reduced to 3-4 so that the cross-links are broken and the gel is less viscous and can be pumped out.
Organometallic-crosslinked fluids zirconium, chromium, antimony, titanium salts are known to crosslink the guar-based gels. The crosslinking mechanism is not reversible. So once the proppant is pumped down along with the cross-linked gel, the fracturing part is done. The gels are broken down with appropriate breakers.
Aluminium phosphate-ester oil gels. Aluminium phosphate and ester oils are slurried to form cross-linked gel.

### EXAMPLES

The following non-limiting example are being provided merely to illustrate some non-limiting embodiments of the present invention. They are not intended to and do not limit the scope of the claims.

### Example 1

### Synthesis with Dichlorosilane

150 ml of 72% aqueous solution of dichlorosilane was poured into a round bottom flask and then warmed up to 150 F. 14.2 ml of a mixture of 0.4% hydrochloric acid and 17% acetic acid was added and the mixture was stirred for 10 minutes. 100 grams of phenolic prepolymer containing at least one methylol functional group was added and the mixture was stirred for 22 minutes. The stirred mixture was then heated up to 260 F to evaporate water and unreacted silane.

### Example 2

### Synthesis with Diphenyl-Monochlorosilane

The procedure of Example 1 was followed except that a 50% solution of diphenyl-monochlorosilane was used in place of the dichlorosilane as the initial reactant in the synthesis.

### Example 3

### Coating of Sand with Product of Example 1

1000 grams of 20/40 fracturing (proppant) sand was coated with the polymer synthesized in Example 1 in a low energy mixture with 0.5% polymer by weight of sand at room temperature. The conductivity of the coated was measured against uncoated sand as control. The results are provided in Table 1.

### Example 4

### Coating of Sand with Product of Example 2

1000 grams of 20/40 fracturing (proppant) sand was coated with the polymer synthesized in Example 2 in a low energy mixture with 0.25% polymer by weight of sand at 150 F. The conductivity of the coated was measured against uncoated sand as control. The results are provided in Table 1.

### Example 5

### Coating of Sand with Product of Example 2

1000 grams of 20/40 fracturing (proppant) sand was coated with 0.25% by weight of the polymer synthesized in Example 2. The mixture was heated up to 420 F. 0.4% of gamma-amino propyl triethoxysilane was added and finally the sand was coated with 3.5% phenolic novolak resin. The conductivity of the coated was measured against uncoated sand as control. The results are provided in Table 1 below.

Conductivity data was obtained using a Fracture Conductivity Cell that allows for samples of proppant of various loading to be subjected to closure stress and temperature over extended time. Fluids are flowed through the pack and from differential pressure measurements the flow capacity of the pack can be determined. The cell is essentially a modified 10 square inch API conductivity cell in which 2 out of three ports are used to measure differential pressure and the center port is used to measure temperature, and instead of each port on a typical API cell being ⅛ inch wide; for these example they are ½ inch wide. Additionally, in a typical API cell, fluid entry and exit ports are ¼ inch wide; for these example, they are ¾ inch wide. A detailed description of the schematic can be found in ISO document number 1-ISO 13503-5:2006(E), herein incorporated by reference. For these examples, the tests were run in one two stack cells. The test procedure is as follows:

Core rocks are selected. For these tests, Ohio sandstone was used. Ohio sandstone has a static elastic modulus of approximately 4 million-psi and a permeability of 0.1 mD. Wafers of thickness 9.5 mm are machined to 0.05 mm precision and one rock is placed in the cell. The selected proppant is sample split and weighed out to simulate proppant loading of 2 lbs/ft̂2. Sample splitting ensures that a representative sample is achieved in terms of its particle size distribution.

The proppant is then placed and leveled into each cell. The top core rock is then inserted. The cell stack is placed on a 100 ton hydraulic press equipped with heated steel plattens to insure uniformity of the heat throughout the stack. A thermocouple is inserted in the middle portion of each cell for temperature recording and reading. The cells were initially set at 80° F. and 1000 psi. The cells were then heated to 150° F. and held for 24 hours at 1000 psi before being ramped to 2000 psi over 10 minutes. Measurements were taken at intervals of 10 hours. After 50 hours a set of measurements was made before the stress was ramped to 4000 psi (total time: 124 hours).

Further measurements were made at 10 hour intervals at 6000 psi. After 50 hours the stress was ramped to 8000 psi, and measurements taken every 10 hours for 50 hours, corresponding to a total time of 224 hours. Similarly, the stress was ramped from 8000 psi to 10,000 psi after 50 hours and measurements were made were made at 10 hour intervals.

TABLE 1
Conductivity (md-ft) at 150 F.

| Closure | 1 | 2 | 3 | 4 | 5 | 6 |
|---|---|---|---|---|---|---|
| 2000 | 4120 | 3817 | 4200 | 3661 | 3973 | 3879 |
| 4000 | 2879 | 2842 | 2693 | 2610 | 2744 | 3517 |
| 6000 | 1346 | 1441 | 1445 | 1520 | 1482 | 1581 |
| 8000 | 437 | 519 | 626 | 610 | 754 | 1544 |
| 10000 | 92 | 112 | 217 | 179 | 202 | 1192 |

1 = Uncoated Coated Frac Sand
2 = Frac Sand coated with 0.25% Polymer in Example 1
3 = Frac Sand coated with 0.25% polymer in Example 2
4 = Frac Sand coated with 0.5% polymer in Example 1
5 = Frac Sand coated with 0.5% polymer in Example 2
6 = Data for Example number 5 in the patent

Any patents, publications, articles, books, journals, brochures, cited therein, are herein incorporated by reference.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

1. A proppant comprising:
a substrate containing silicon; and,
a silane coating comprising a central silicon atom, a first L atom directly bonded to the central silicon atom to create an Si-L linkage, a prepolymer that is bonded directly the central silicon atom or bridged to the central silicon atom by a second L atom directly bonded to the central silicon atom to create an Si-L-prepolymer linkage;
wherein silicon in the substrate is bonded directly to the first L atom to form an Si-L-Si linkage between the silicon in the substrate and the central silicon atom in the coating;
and wherein L is selected from the group consisting of boron (B), nitrogen (N), oxygen (O), phosphorus (P) and sulphur (S).

2. The proppant of claim 1, wherein the substrate is sand.

3. The proppant of claim 1, wherein the prepolymer is a self crosslinkable phenolic polymer.

4. The proppant of claim 1, wherein L is oxygen (O), wherein the substrate is sand, and wherein the prepolymer is a self crosslinkable phenolic polymer.

5. A proppant comprising:
a substrate containing silicon; and,
a coating composition comprising: 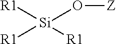
wherein Si is silicon with 3 pendant groups R1, wherein the R1 groups may be the same or different; wherein at least one R1 comprises R2 or —O—R2, wherein O is oxygen and R2 is a crosslinkable prepolymer; wherein at least one R1 comprises —O—R3, wherein O is as defined above and; wherein the remaining R1 comprise R5, wherein R5 is selected from among H, —O—R2, —O—R3, or —R4, where R2 is as defined above, R3 is selected from among H or —R4OH, wherein H is hydrogen, and R4 is a substituted or unsubstituted hydrocarbon group; and, wherein each of R2, R3, R4 and R5 are independently selected so that each R1 may be the same or different, and wherein Z represents the position that the silicon in the substrate bonds to O of the composition.

6. The proppant of claim 5, wherein the substrate is sand.

7. The proppant of claim 6, wherein R2 is a self crosslinkable phenolic polymer.

8. A proppant comprising
a substrate containing silicon; and,
a coating composition comprising: 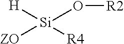
wherein R2 is a crosslinkable prepolymer, wherein R4 is a substituted or unsubstituted hydrocarbon group, and wherein Z represents the silica in the substrate bonding to O of the composition.

9. The proppant of claim 8, wherein the substrate is sand.

10. The proppant of claim 9, wherein R2 is a self crosslinkable phenolic polymer.

11. A method of making a proppant comprising:
Contacting a substrate containing silicon with a silane coating,
Wherein the silane coating comprises a central silicon atom, a first L atom directly bonded to the central silicon atom to create an Si-L linkage, a prepolymer that is bonded directly the central silicon atom or bridged to the central silicon atom by a second L atom directly bonded to the central silicon atom to create an Si-L-prepolymer linkage;
and wherein L is selected from the group consisting of boron (B), nitrogen (N), oxygen (O), phosphorus (P) and sulphur (S);
to form a proppant in which the silicon in the substrate is bonded directly to the first L atom in the coating to form an Si-L-Si linkage between the silicon in the substrate and the central silicon atom in the coating.

12. The method of claim 11, wherein the substrate is sand.

13. The method of claim 11, wherein the prepolymer is a self crosslinkable phenolic polymer.

14. The method of claim 11, wherein L is oxygen (O), wherein the substrate is sand, and wherein the prepolymer is a self crosslinkable phenolic polymer.

15. A method of making a proppant comprising:
Contacting a substrate containing silicon with a coating composition,
Wherein the coating composition comprises: 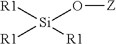
wherein Si is silicon with 3 pendant groups R1, wherein the R1 groups may be the same or different; wherein at least one R1 comprises R2 or —O—R2, wherein O is oxygen and R2 is a crosslinkable prepolymer; wherein at least one R1 comprises —O—R3, wherein O is as defined above and; wherein the remaining R1 comprise R5, wherein R5 is selected from among H, —O—R2, —O—R3, or —R4, where R2 is as defined above, R3 is selected from among H or —R4OH, wherein H is hydrogen, and R4 is a substituted or unsubstituted hydrocarbon group; and, wherein each of R2, R3, R4 and R5 are independently selected so that each R1 may be the same or different,
to form a proppant in which Z represents the position that the silicon in the substrate bonds to O of the coating composition.

16. The method of claim 15, wherein the substrate is sand.

17. The method of claim 16, wherein R2 is a self crosslinkable phenolic polymer.

18. A method of making a proppant comprising:
Contacting a substrate containing silicon with a coating composition,
Wherein the coating composition comprises: 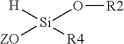
wherein R2 is a crosslinkable prepolymer, wherein R4 is a substituted or unsubstituted hydrocarbon group,
to form a proppant in which Z represents the position that silicon in the substrate bonds to O of the composition.

19. The proppant of claim 18, wherein the substrate is sand.

20. The proppant of claim 19, wherein R2 is a self crosslinkable phenolic polymer.

21. A hydraulic fracturing fluid comprising a liquid portion and proppants,
Wherein the proppant comprises:
a substrate containing silicon; and,
a silane coating comprising a central silicon atom, a first L atom directly bonded to the central silicon atom to create an Si-L linkage, a prepolymer that is bonded directly the central silicon atom or bridged to the central silicon atom by a second L atom directly bonded to the central silicon atom to create an Si-L-prepolymer linkage;
wherein silicon in the substrate is bonded directly to the first L atom to form an Si-L-Si linkage between the silicon in the substrate and the central silicon atom in the coating;
and wherein L is selected from the group consisting of boron (B), nitrogen (N), oxygen (O), phosphorus (P) and sulphur (S).

22. The hydraulic fracturing fluid of claim 21, wherein the substrate is sand.

23. The hydraulic fracturing fluid of claim 21, wherein the prepolymer is a self crosslinkable phenolic polymer.

24. The hydraulic fracturing fluid of claim 21, wherein L is oxygen (O), wherein the substrate is sand, and wherein the prepolymer is a self crosslinkable phenolic polymer.

25. A hydraulic fracturing fluid comprising a liquid portion and proppants,
Wherein the proppant comprises:
a substrate containing silicon; and,
a coating composition comprising: 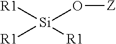
wherein Si is silicon with 3 pendant groups R1, wherein the R1 groups may be the same or different; wherein at least one R1 comprises R2 or —O—R2, wherein O is oxygen and R2 is a crosslinkable prepolymer; wherein at least one R1 comprises —O—R3, wherein O is as defined above and;
wherein the remaining R1 comprise R5, wherein R5 is selected from among H, —O—R2, —O—R3, or —R4, where R2 is as defined above, R3 is selected from among H or —R4OH, wherein H is hydrogen, and R4 is a substituted or unsubstituted hydrocarbon group; and, wherein each of R2, R3, R4 and R5 are independently selected so that each R1 may be the same or different, and wherein Z represents the position that the silicon in the substrate bonds to O of the composition.

26. The hydraulic fracturing fluid of claim 25, wherein the substrate is sand.

27. The hydraulic fracturing fluid of claim 26, wherein R2 is a self crosslinkable phenolic polymer.

28. A hydraulic fracturing fluid comprising a liquid portion and proppants,
The proppant comprising:
a substrate containing silicon; and,
a coating composition comprising: 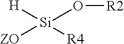
wherein R2 is a crosslinkable prepolymer, wherein R4 is a substituted or unsubstituted hydrocarbon group, and wherein Z represents the position wherein the silicon in the substrate bonds to O of the composition.

29. The hydraulic fracturing fluid of claim 28, wherein the substrate is sand.

30. The hydraulic fracturing fluid of claim 29, wherein R2 is a self crosslinkable phenolic polymer.

31. A method of hydraulically fracturing a subterranean formation penetrated by a wellbore, comprising: forcing fracturing fluid into the wellbore at a sufficient pressure so that the fracturing fluid forms fractures in the subterranean formation, and releasing the pressure and allowing at least a portion of the proppant to remain in the fractures in the subterranean formation; Wherein the proppant comprises:
a substrate containing silicon; and,
a silane coating comprising a central silicon atom, a first L atom directly bonded to the central silicon atom to create an Si-L linkage, a prepolymer that is bonded directly the central silicon atom or bridged to the central silicon atom by a second L atom directly bonded to the central silicon atom to create an Si-L-prepolymer linkage;
wherein silicon in the substrate is bonded directly to the first L atom to form an Si-L-Si linkage between the silicon in the substrate and the central silicon atom in the coating;
and wherein L is selected from the group consisting of boron (B), nitrogen (N), oxygen (O), phosphorus (P) and sulphur (S).

32. The hydraulic fracturing fluid of claim 31, wherein the substrate is sand.

33. The hydraulic fracturing fluid of claim 31, wherein the prepolymer is a self crosslinkable phenolic polymer.

34. The hydraulic fracturing fluid of claim 31, wherein L is oxygen (O), wherein the substrate is sand, and wherein the prepolymer is a self crosslinkable phenolic polymer.

35. A method of hydraulically fracturing a subterranean formation penetrated by a wellbore, comprising: forcing fracturing fluid into the wellbore at a sufficient pressure so that the fracturing fluid forms fractures in the subterranean formation, and releasing the pressure and allowing at least a portion of the proppant to remain in the fractures in the subterranean formation;
Wherein the proppant comprises:
a substrate containing silicon; and,
a coating composition comprising: 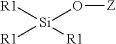
wherein Si is silicon with 3 pendant groups R1, wherein the R1 groups may be the same or different; wherein at least one R1 comprises R2 or —O—R2, wherein O is oxygen and R2 is a crosslinkable prepolymer; wherein at least one R1 comprises —O—R3, wherein O is as defined above and;
wherein the remaining R1 comprise R5, wherein R5 is selected from among H, —O—R2, —O—R3, or —R4, where R2 is as defined above, R3 is selected from among H or —R4OH, wherein H is hydrogen, and R4 is a substituted or unsubstituted hydrocarbon group; and, wherein each of R2, R3, R4 and R5 are independently selected so that each R1 may be the same or different, and wherein Z represents the position that the silicon in the substrate bonds to O of the composition.

36. The hydraulic fracturing fluid of claim 35, wherein the substrate is sand.

37. The hydraulic fracturing fluid of claim 36, wherein R2 is a self crosslinkable phenolic polymer.

38. A method of hydraulically fracturing a subterranean formation penetrated by a wellbore, comprising: forcing fracturing fluid into the wellbore at a sufficient pressure so that the fracturing fluid forms fractures in the subterranean formation, and releasing the pressure and allowing at least a portion of the proppant to remain in the fractures in the subterranean formation;
The proppant comprising:
a substrate containing silicon; and,
a coating composition comprising: 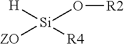
wherein R2 is a crosslinkable prepolymer, wherein R4 is a substituted or unsubstituted hydrocarbon group, and wherein Z represents the position wherein the silicon in the substrate bonds to O of the composition.

39. The hydraulic fracturing fluid of claim 38, wherein the substrate is sand.

40. The hydraulic fracturing fluid of claim 39, wherein R2 is a self crosslinkable phenolic polymer.
